(19) United States
(12) Patent Application Publication
(10) Pub. No.: US 2010/0052547 A1
(43) Pub. Date: Mar. 4, 2010

(54) ILLUMINATION SYSTEM

(75) Inventor: Roger Peter Anna Delnoij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,992

(22) PCT Filed: Nov. 27, 2007
(86) PCT No.: PCT/IB07/54800

§ 371 Date: May 22, 2009

(30) Foreign Application Priority Data
Nov. 30, 2006 (EP) 06125081.7

(51) Int. Cl. H05B 37/02; G01J 3/46

(52) U.S. Cl. 315/152; 356/402

(57) ABSTRACT

An illumination system (1) comprises a plurality of lamps (11, 12, 13) for generating light (R, G, B) with mutually different colors; in an embodiment, the lamps are fluorescent lamps. A sensing system (50) comprising a color sensor (51) provides a sensor output signal (Ss) that indicates the color of the light received by the color sensor. The sensing system comprises a light guide arrangement (60) interposed between the lamps and the sensor, which is arranged in a service room (74) shielded from ambient light. Each light guide captures light from one lamp only, and the sensor receives a mixture of the captured lights. The color sensor and light guide are used in a feedback system that corrects for tolerances, lamp aging, ambient temperature etc.

### FIELD OF THE INVENTION

The present invention relates in general to an illumination system for generating light, comprising multiple light sources each generating mutually different colors, and each being controllable such that the individual light intensities can be varied. The system further comprises a controller, generating control signals for the individual lamps in order to set the individual light intensities of the individual lamps. The light sources may be of any suitable type, for instance fluorescent lamps, LEDs, etc; hereinafter, the present invention will be explained for the case of fluorescent lamps, but it is stressed that the invention is not restricted to fluorescent lamps. In a typical embodiment, the system comprises three lamps, respectively generating red light, green light, and blue light, so that the system is indicated as an RGB system; hereinafter, the present invention will be explained for the case of an RGB system, but it is stressed that the invention is not restricted to RGB systems.

### BACKGROUND OF THE INVENTION

The three lamps are mounted relatively close together, typically in a common housing or armature, so that, at some distance from the lamps, the individual light components have mixed, and an observer would observe mixed light with a color point located, in a suitable color space, at some point within the triangle defined by the three color points of the individual colors, the exact location of the color point of the mixture depending on the relative intensities of the individual lamps. By varying the relative intensities of the individual lamps, it is possible to generate any possible color within said triangle, including white, as should be clear to a person skilled in the art.

There are situations where the accuracy of the color of the mixture is important. For instance, in a room with two or more different illumination systems, intended for generating the same color, the human eye is sensitive enough to notice even slight color differences between the different systems. A problem in this respect is that in practice the relationship between control signal and output light intensity may vary from lamp to lamp and/or as a function of time, for instance due to tolerances, aging, ambient temperature, etc.

To overcome this problem, an illumination system may be provided with a sensing system, comprising a color sensor which senses the actually generated light and produces a measuring signal for the controller, indicating the color of the light mixture, so that the controller can adapt its control signals. A further problem then is to find a suitable location for such sensor. On the one hand, the sensor should be placed at a far enough distance from the individual light sources so that the light at that location is actually mixed, but on the other hand it is not desirable that the sensor itself is visible and/or blocking a portion of the light output. Further, the sensor should not be disturbed by ambient light. It practice, it is very difficult to meet all these requirements.

It is a general objective of the present invention to provide a solution to these problems.

### SUMMARY OF THE INVENTION

According to a first important aspect of the present invention, the sensing system further comprises a light guide arrangement, comprising a plurality of light guides, each light guide having an input end located close to a respective light source and having an output end located close to the sensor. With such a light guide arrangement, it is possible to locate the light sensor within the lamp housing or armature, shielded from ambient light, and at a location where the temperature does not become extremely hot. The light sensor does not receive the light directly, but through the light guides, so the location of the light sensor itself does not have to be a location where the light is mixed. Each light guide can have its input end mounted close to a respective lamp, at a position where it does not block the output light. All light guides guide their sampled light to the same light sensor, so that the light sensor receives mixed light.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically illustrating an illumination system;

FIGS. 2A and 2B schematically illustrate design details of a light guide system according to the present invention;

FIG. 3 is a diagram schematically illustrating a practical embodiment of the illumination system according to the present invention.

### DETAILED DESCRIPTION OF THE INVENTION

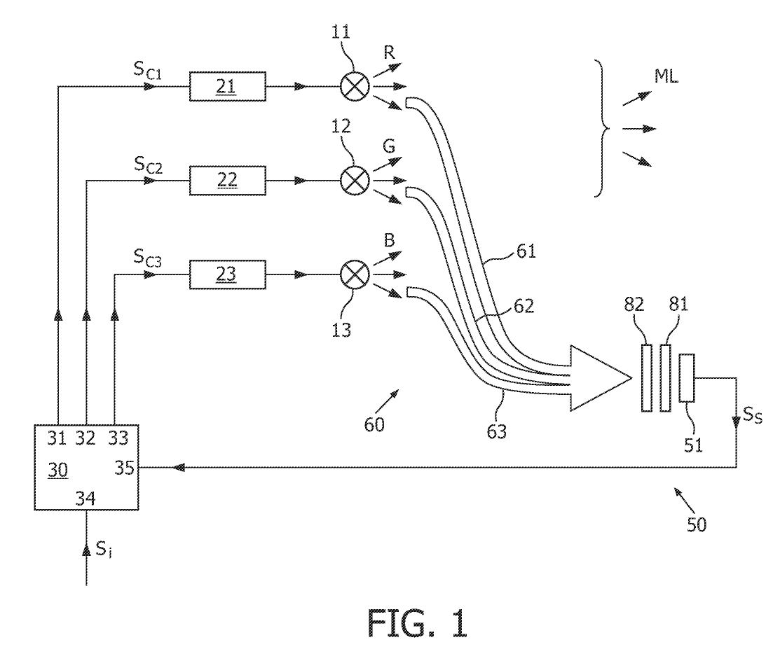

FIG. 1 is a block diagram schematically illustrating an illumination system 1 according to the present invention. In the illustrated embodiment, the system comprises three lamps 11, 12, 13 with associated drivers 21, 22, 23 and a controller 30, which has three outputs 31, 32, 33 producing respective control signals Sc1, Sc2, Sc3 for the respective drivers 21, 22, 23. Illustratively, the first lamp 11 produces red light R, the second lamp 12 produces green light G, and the third lamp 13 produces blue light B. At a far enough distance, the light output of the three individual lamps 11, 12, 13 is mixed, and an observer observes mixed light ML. As should be clear to a person skilled in the art and therefore needs no further explanation, the color of the mixed light as observed by a human observer depends on the relative intensities of the individual light outputs. The controller 30 has a target input 34 for receiving a target input signal Si, indicating a required color of the mixed light ML. The target input 34 may be coupled to a user input (not shown) for receiving a variable user input signal. A user input device to be operated by the user for generating such user input signal may be any suitable type of device, for instance a keyboard, a variable voltage source, a variable resistance, etc, but it may also be that the user input signal Si is generated by a computer system, for instance PC; for sake of simplicity, such user input device is not shown. It is noted that, instead of a variable setting, the controller 30 may also operate with a fixed setting in cases where it is not intended to vary the output color; in such cases, the target input 34 may be coupled to a constant signal source, which may be implemented by a memory, for instance a RAM.

The illumination system 1 further comprises a sensing system 50, comprising a color sensor 51 receiving mixed light and generating a sensor output signal Ss that indicates the color of the light received by the color sensor 51. The sensor output signal Ss may also indicate the intensity of the light received by the color sensor 51. It is noted that suitable color sensors are known per se, that the present invention can be implemented with currently known color sensors, and that the present invention does not aim to provide an improved color sensor, so it is not necessary here to give an elaborate description of design and functioning of the color sensor.

The controller 30 has a sensor input 35, coupled to receive the sensor output signal Ss. The controller 30 compares the received sensor output signal Ss with a reference that is based on the input signal Si and/or on the control output signals Sc1, Sc2, Sc3. If the controller 30 finds that the sensor output signal Ss deviates from expected value as expressed by the reference, it adapts its control output signals Sc1, Sc2, Sc3 such as to reduce the deviation. Thus, the sensing system 50 provides a feedback loop allowing the controller 30 to set and/or maintain the color and intensity of the mixed output light ML at a required value.

According to an important aspect of the present invention, the sensing system 50 comprises a light guide arrangement 60 interposed between the lamps 11, 12, 13 and the sensor 51. The light guide arrangement 60 comprises, for each lamp 11, 12, 13, an associated light guide 61, 62, 63 having an input end 61a, 62a, 63a disposed close to the corresponding lamp such that it receives light substantially from that corresponding lamp only, and having an output end 61b, 62b, 63b disposed close to the sensor 51 such as to provide the captured light to the sensor 51. Thus, the sensor 51 can be arranged at a location where the actual mixed output light ML is not present, for instance inside an associated armature, as will be explained later.

It is noted that light guides are known per se, that the present invention can be implemented with known light guides, an that the present invention does not aim to provide an improved light guide, so it is not necessary here to give an elaborate description of design and operation of light guides. By way of example only, it is noted that a light guide can be implemented as an optical fibre, or more generally a body of dielectric material with high permittivity and high index of refraction surrounded by a material with lower permittivity and lower index of refraction such as to provide total internal reflection. As another example, a light guide can be implemented as a hollow tube with reflective inner walls.

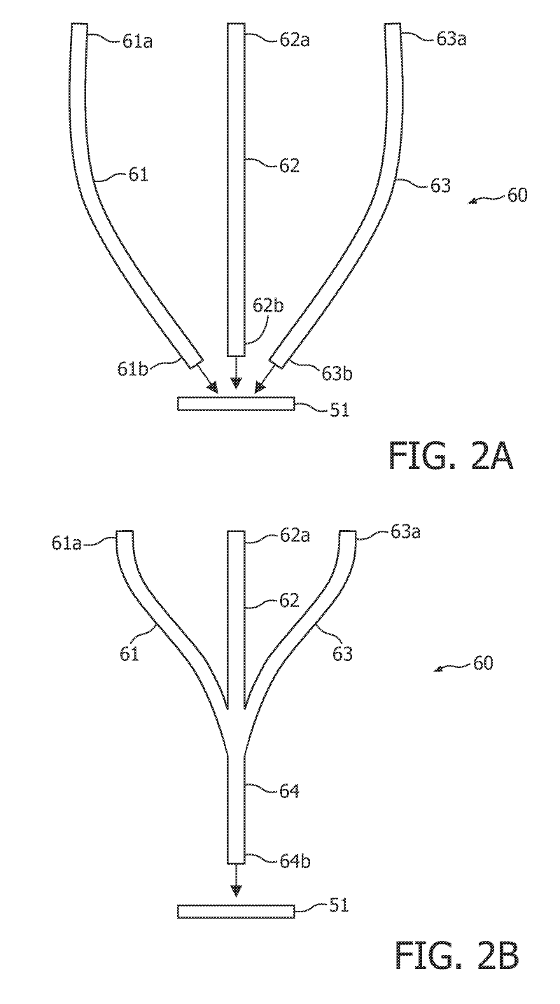

FIG. 2A schematically illustrates that each light guide 61, 62, 63 may be completely separate from the other light guides, and that the light guides 61, 62, 63 may have their respective output ends 61b, 62b, 63b arranged close to the sensor 51 and directed so that the captured light of each light guide irradiates the sensor 51. In such case, mixture of the captured light samples takes place in the space between the light guides and the sensor and/or on the light sensitive surface of the sensor 51. The figure further shows that a light guide may have a straight shape from input end to output end (see 62), or may have a curved shape from input end to output end (see 61, 63).

In an alternative embodiment, schematically illustrated in FIG. 2B, the separate light guides 61, 62, 63 may meet each other and merge into one combined light guide portion 64 having its output end 64b arranged close to the sensor 51 and directed so that the mixture of captured lights from the light guides irradiates the sensor 51. In such case, mixture of the captured light samples takes place in the combined light guide portion 64.

It is noted that, in both cases, the sensor 51 measures mixed light, in which the relative proportions of the individual light contributions depend on the actual dimensions of the light guides and the exact dispositioning of their respective input ends. Further, the sensor 51 may have different sensitivity properties for the different individual colors. It should be clear to a person skilled in the art that it is possible, in a calibration procedure, to determine the actual response of the sensor 51 to the individual light outputs, which calibration procedure may provide correction factors that may be stored by the controller 30 in an associated memory, so that at all times the controller 30 is capable to determine the actual individual light output level of each individual lamp on the basis of the sensor output signal Ss.

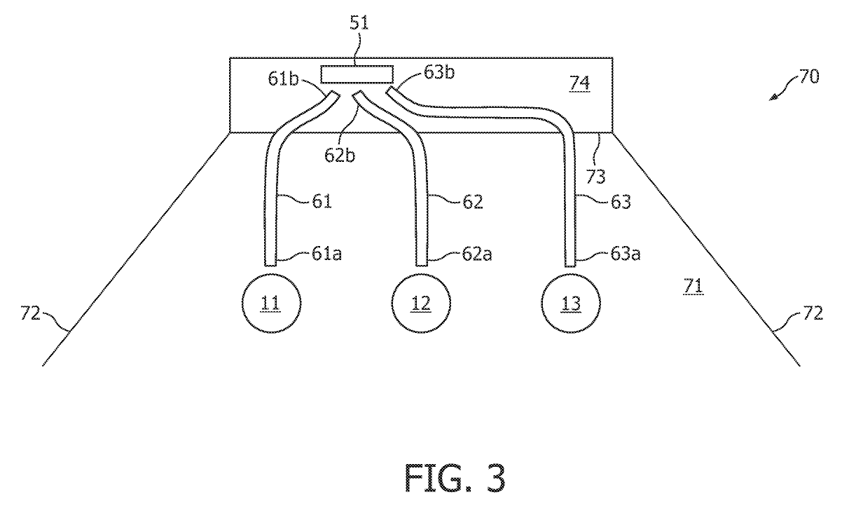

FIG. 3 is a diagram, schematically illustrating a practical embodiment of the illumination system 1. The diagram shows a schematic cross section of an armature 70 accommodating three fluorescent lamps 11, 12, 13 in the form of tubes arranged parallel to each other in a lamp room 71 having side walls 72 and an upper wall 73; at the lower end 75, the lamp room 71 is open allowing light to leave the armature. Above the lamp room 71, the armature 70 comprises a service room 74 accommodating the sensor 51 and possibly also, though not shown, the controller 30 and the drivers 21, 22, 23. The service room 74 is substantially closed such as to prevent ambient light from reaching the sensor 51, and such as to prevent light from the lamps 11, 12, 13 from reaching the sensor 51 directly. The figure shows the light guides 61, 62, 63 extending from the lamps 11, 12, 13 through the upper lamp room wall 73 to the sensor 51 in the service room 74. The input end 61a, 62a, 63a of a light guide 61, 62, 63 is arranged above the corresponding lamp 11, 12, 13, i.e. opposite the lower lamp room end where the light emerges from the lamp room, so that the light guides do not block the light. Described in a different way: if the side of the lamp directed towards the outlet side 75 of the lamp room 71 is indicated as front side while the opposite side of the lamp is indicated as back side, the input end 61a, 62a, 63a of a light guide 61, 62, 63 is arranged facing the back side of the corresponding lamp. Alternatively, it is possible that the input end 61a, 62a, 63a of a light guide 61, 62, 63 is arranged besides the corresponding lamp.

Typically, the sensor 51 is also sensitive to infrared radiation. Therefore, in a preferred embodiment, the system comprises an infrared filter 81 preventing infrared light from reaching the sensor 51. Advantageously, such infrared filter 81 may be arranged directly over the sensor 51, as schematically illustrated in FIG. 1. It is noted that such filters are known per se. It is further noted that such filter may be omitted in cases where the sensor 51 is not sensitive for infrared.

Typically, the sensor 51 is also sensitive to ultraviolet radiation, or such radiation may even reduce the lifetime of the sensor. Therefore, in a preferred embodiment, the system comprises an ultraviolet filter 82 preventing ultraviolet light from reaching the sensor 51. Advantageously, such ultraviolet filter 82 may be arranged directly over the sensor 51, as schematically illustrated in FIG. 1. It is noted that such filters are known per se. It is further noted that such filter may be omitted in cases where the sensor 51 is not sensitive for ultraviolet.

Alternatively, infrared filter 81 and/or ultraviolet filter 82 may be incorporated in the light guide arrangement 60, i.e. in the individual light guides 61, 62, 63 or, if present, in the combined light guide portion 64.

Summarizing, the present invention provides an illumination system 1 comprising a plurality of lamps 11, 12, 13 for generating light R, G, B with mutually different colors. In an embodiment, the lamps are fluorescent lamps.

A sensing system 50 comprising a color sensor 51 provides a sensor output signal Ss that indicates the color of the light received by the color sensor.

The sensing system comprises a light guide arrangement 60 interposed between the lamps and the sensor, which is arranged in a service room 74 shielded from ambient light. Each light guide captures light from one lamp only, and the sensor receives a mixture of the captured lights.

The color sensor and light guide are used in a feedback system that corrects for tolerances, lamp aging, ambient temperature etc.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, the three drivers 21, 22, 23 may be integrated into one driver with three outputs. Also, the controller 30 and the drivers 21, 22, 23 may be integrated.

Further, it may be that the armature comprises further optical components, not shown in the figures. For instance, the armature may additionally be provided with a diffuser, positioned as far away from the lamps a possible, to improve the mixing of the light components of the individual lamps.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Illumination system (1), comprising:
at least two lamps (11, 12, 13) for generating light (R, G, B) with mutually different colors;
a sensing system (50) comprising a color sensor (51) for providing a sensor output signal (Ss) that indicates the color of the light received by the color sensor;
wherein the sensing system (50) comprises a light guide arrangement (60) interposed between the lamps (11, 12, 13) and the sensor (51).

2. Illumination system according to claim 1, wherein the light guide arrangement (60) comprises a plurality of light guides (61, 62, 63), each light guide being associated with a corresponding lamp (11, 12, 13), wherein each light guide (61, 62, 63) has an input end (61a, 62a, 63a) disposed close to the corresponding lamp (11, 12, 13) and has an output end (61b, 62b, 63b) disposed close to the sensor (51).

3. Illumination system according to claim 2, wherein the output end (61b, 62b, 63b) of each light guide (61, 62, 63) is directed such that the captured light of each light guide irradiates the sensor (51).

4. Illumination system according to claim 1, wherein the light guide arrangement (60) comprises a plurality of light guides (61, 62, 63), each light guide being associated with a corresponding lamp (11, 12, 13) and having an input end (61a, 62a, 63a) disposed close to the corresponding lamp (11, 12, 13);
wherein the light guide arrangement (60) further comprises a combined light guide portion (64) having an output end (64b) arranged close to the sensor (51);
wherein the plurality of light guides (61, 62, 63) meet each other and merge into the combined light guide portion (64).

5. Illumination system according to claim 4, wherein the output end (64b) of the combined light guide portion (64) is directed such that the mixture of captured lights from the light guides (61, 62, 63) irradiates the sensor (51).

6. Illumination system according to claim 1, further comprising an infrared filter (81) arranged for preventing infrared light from reaching the sensor (51).

7. Illumination system according to claim 6, wherein the infrared filter (81) is incorporated in the light guide arrangement (60).

8. Illumination system according to claim 1, further comprising an ultraviolet filter (82) arranged for preventing ultraviolet light from reaching the sensor (51).

9. Illumination system according to claim 6, wherein the ultraviolet filter (82) is incorporated in the light guide arrangement (60).

10. Illumination system according to claim 1, further comprising an armature (70) having a lamp room (71) in which the lamps (11, 12, 13) are arranged, and having a service room (74) in which the sensor (51) is arranged, the lamp room (71) having at least one outlet opening (75) for the light (R, G, B) from the lamps (11, 12, 13), the service room being substantially closed;
wherein the light guides (61, 62, 63) have their input ends (61a, 62a, 63a) at a position outside a direct path from the corresponding lamp (11, 12, 13) to the outlet opening (75).

11. Illumination system according to claim 10, wherein each lamp (11, 12, 13) has a front side directed towards the outlet side (75) of the lamp room (71) and a back side opposite the front side, and wherein the input ends (61a, 62a, 63a) of the light guides (61, 62, 63) are arranged facing the back side of the corresponding lamp.

12. Illumination system according to claim 1, further comprising:
a controller (30) for generating control signals (Sc1, Sc2, Sc3) for controlling the respective intensities of the respective lamps;
wherein the controller, in response to the sensor output signal (Ss), is designed to adapt its control signals (Sc1, Sc2, Sc3) such that the sensor output signal (Ss) at least substantially corresponds to a reference signal.

13. Method for controlling lamps (11, 12, 13) in an illumination system (1), the method comprising the steps of:
capturing a portion of the light (R, G, B) generated by the individual lamps;
guiding the captured lights to a color sensor (51) using a light guide system (60).
